(19) United States
(12) Patent Application Publication
(10) Pub. No.: US 2004/0073783 A1
(43) Pub. Date: Apr. 15, 2004

(54) Computer system with operating system on a ram-disk

(76) Inventor: Gordon Ritchie, London (GB)

Correspondence Address: Brown Raysman Millstein, Felder & Steiner, 900 Third Avenue, New York, NY, 10022, US

(21) Appl. No.: 10/466,021

(22) PCT Filed: Jan. 8, 2002
(86) PCT No.: PCT/GB02/00058

(30) Foreign Application Priority Data
Jan. 8, 2001 (GB) 0100434.0
Mar. 9, 2001 (GB) 0105792.6

(51) Int. Cl. G06F 15/177

(52) U.S. Cl. 713/1

(57) ABSTRACT

A method of configuring a computer to run an operating system from RAM includes creating a copy of the operating system on a hard disk at a first address (116), the operating system being configured to run from a second address (112). A RAMdisk is created having a RAMdisk address and the operating system is copied from the hard disk to the RAMdisk. The computer is reconfigured (118,120) so that the second address, from which the operating system copy is configured to run is the RAMdisk address or is treated by the computer as being the RAMdisk address, so that the operating system copy can be run on the RAMdisk.

This invention relates to systems for running large operating systems on computers in RAM and in particular, but not exclusively, embodiments of the invention provide means for running Microsoft Windows™ 95 and Microsoft Windows™ 98 operating systems in and from a RAMdisk.

A RAMdisk is an area of RAM which is configured to mimic a Hard Disk. It is a virtual hard disk. It is also possible to configure RAM in other ways than a RAMdisk and still run an operating system from RAM. A RAMdisk as referred to herein is thus not limited to such Hard Disk mimicking configurations, but to any RAM configuration from which an operating system can be run.

More specifically this invention relates to a means for:

[1] Installing a large operating system, preferably Microsoft Windows™ 95 or 98 in RAM, preferably on a RAMdisk

[2] Loading a large operating system, preferably Microsoft Windows™ 95 or 98 into RAM, preferably on to a RAMdisk, when the computer starts up, before the large operating system itself is started, preferably before the Windows™ operating system (Win.com) is started.

[3] Running a large operating system, preferably Microsoft Windows™ 95 or 98 from and in RAM, preferably from and in a RAMdisk. In particular for saving modifications to the Operating System, and for saving programs and applications which are installed and are run on and by the operating system, on a non volatile storage means which maintains the data when the power to the computer is turned off, preferably a Hard Disk, which mirrors the RAMdisk.

Personal Computers have hitherto run Windows™ operating systems from Hard Disks. This has occurred because the first widely used commercial operating system for PCs was DOS, a DISK Operating System (not a RAM operating system), and subsequent operating systems such as Windows™, OS/2™ and Linux™ have followed this mode of operation.

It is known for computers to run operating systems from RAM. These have generally been small operating systems of around 10 MB in size. The problem with running an operating system from a Hard Disk, is that since it is a mechanical device, it is relatively slow to process data as compared to the rest of the computer which is an electronic device. The best hard disks today (2001) can access data in around 5 ms and can read and write data at a rate of between 30 and 50 MB/sec. But RAM, which is an electronic device can do these operations between 10 and 100 times faster. In fact DDRAM can transfer data at 2 GB/sec (January 2001).

So it is desirable to run any operating system from RAM rather than from a Hard Disk. But there are various difficulties in doing this which have prevented this occurring before now especially in the case of Microsoft Windows™ and other large operating systems. These are:

[1] In order to install Microsoft Windows™ 95/98 in a PC one needs to restart the computer several times. And when a computer is restarted, the contents of its RAM are lost.

[2] If Microsoft Windows™ 95/98 is running from RAM, then when the PC is turned off, the whole operating system is lost.

It would be possible for Microsoft to redesign Windows™ 95 or Windows™ 98 for RAMdisk installation, by giving the user the opportunity to restart or not, manually, during the installation or by dropping to native DOS (the operating system underneath Windows™ 95 and Windows™ 98) automatically rather than restarting automatically. If they did then one could run a copying program (which runs in native DOS) to copy the contents of the RAMdisk to the Hard Disk before manually restarting. In this way the part of the installation already completed would be preserved on the hard disk when the computer was restarted. One could then load this part installation back to the RAMdisk after the restart and continue installing the operating system on to the RAMdisk.

However, because they have not done this and because the inventor knows of no way to stop the installation and drop to native DOS without restarting the computer, a different approach is required. This technical barrier is one reason why it has not been known in the past to run Microsoft Windows™ 95 or 98 from a RAMdisk on a stand alone PC.

[3] Microsoft Windows™ 95/98 are large operating systems, being over 100 MB in size. Operating systems of this size have hitherto not been rum from RAM in general, and Microsoft provide a RAMdisk program which can only create a 64 MB RAMdisk.

[4] Large amounts of RAM in PCs (256 MB and above) have only been commercially available since 1996.

[5] Large RAMdisk programs (for RAMdisks of greater than 100 MB), which configure RAM to act like a Hard Disk are not generally known, but became commercially available in 1996.

[6] There is a general misconception in the industry that Microsoft Windows™ 95 and 98 manage memory so well that configuring program RAM as a RAMdisk, and therefore making it unavailable to the operating system, will only slow down a computer. This misconception arises because people are not aware that although these two operating systems can address 4 GB of RAM they have an optimum memory addressing size of 500 MB. If one uses more than 500 MB of program RAM then the operating systems do not perform better than they do with 500 MB, they actually run considerably slower. For example a computationally intensive Microsoft Access Query will run around 50% slower in 750 MB of program RAM, i.e. operating system RAM, than it will in 500 MB of program RAM. This occurs because Windows does not address RAM over 500 MB properly and historically it was not thought likely that personal computers would have more than 500 MB of RAM.

There are two fixes to this recognised problem with Windows™ 95/98 suggested by Microsoft on their Knowledge base Website. One is to limit the amount of installed memory that Windows actually sees using the MaxPhysPage command in the 386Enhanced section of the Windows™ System.ini file. This can be done by using the command: MaxPhysPage=1F3FF for example, which will limit the RAM that Windows sees to 500 MB. The other fix is to restrict the Windows™ ‘vcache’, which is a memory cache of recently loaded files. One should restrict it to 25% of the RAM that Windows actually sees. Even with these fixes, Windows™ 95 and Windows™ 98 still perform slower with installed (albeit supposedly invisible) memory over 500 MB than they do with installed memory of less than 500 MB.

So there is no point in having more than 500 MB of program/operating system RAM with either of these operating systems. The industry has suffered from a prejudice against RAMdisks for these reasons.

It is known to provide a Solid State Hard Drive. This is a device which is a hard disk with its own integral RAMdisk mirror. It has some of the speed advantages of RAM and the power off memory of a Hard Disk. A Commercial example is the Quantum Rushmore Solid State Drive. The disadvantage of these dual RAM and Hard Disk drives is that they are extremely expensive, costing 10 times as much as a PC, for a 500 MB drive in 2001.

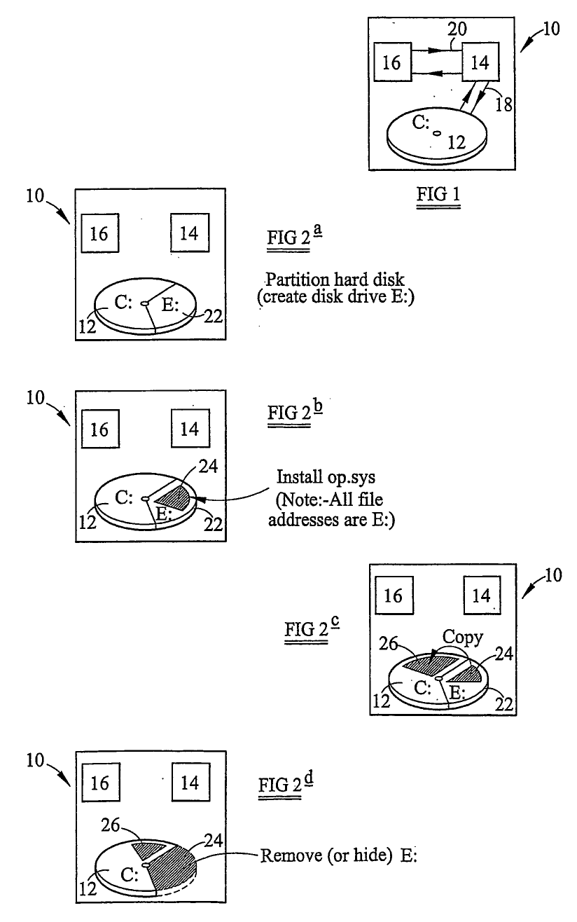

A further disadvantage is that solid state disk drives communicate with the computer processor through a Hard Disk BUS, generally a SCSI BUS. A BUS is a connecting means in a computer, it is a communication highway. FIG. 1 is a schematic diagram showing a configuration common to most of today's PCs. The computer (10) has its own internal RAM (16) directly addressable by the CPU (14), through the RAM BUS (20). The RAM BUS (20) is also called the Front Side BUS, it is the Motorway between the CPU (14) and the RAM (16). This RAM BUS (20) runs faster than the Hard Disk BUS (18), since it is designed to cope with the speed of an electronic storage device rather than with a mechanical one. The Hard Disk BUS (18) is also called the Back Side BUS, and it is the ‘B Road’ between the CPU (14) and the Hard Disk (12).

However, notwithstanding the huge price of Solid State Disks, there is a market for these devices as such is the demand for speed from online banking servers and Web servers etc. The Solid State Disk, uses the faster electronic storage means, but communicates with the CPU via the slower communication means, the ‘B Road’.

It is therefore an aim of the present invention to provide means for installing and running a large operating system on a computer from the computer's RAM.

It should be appreciated that the term “address” referred to herein represents any data location accessible to a computer. The location may be a drive, the address being a drive code (letter) or any means of labelling the drive, or the address may refer to a location within a drive and may include a directory path.

‘Local Address’ means any data location accessible to a PC and local to the PC. Where data is stored on a second computer which is connected to the first computer by means of a network or the likes, it is not local to the first computer.

According to a first aspect of the present invention, there is provided a method of configuring a computer to run an operating system from RAM, the method comprising:

[1] creating a copy of the operating system on a hard disk at a first address, the operating system copy being configured to run from a second address;

[2] creating a RAMdisk having a RAMdisk address;

[3] copying the operating system copy from the hard disk to the RAMdisk; and

[4] reconfiguring the computer so that the second address, from which the operating system is configured to run is the RAMdisk address or is treated by the computer as being the RAMdisk address, so that said operating system copy can be run on the RAMdisk.

In a preferred embodiment the operating system is any version of Windows 95 or any version of Windows 98.

Preferably, the operating system is any version of any operating system capable of running Microsoft Word 2000, Access 2000, Excel 2000, and Frontpage 2000.

The 1^{st} step may comprise creating a partition of a hard disk, said partition having the first address and creating the copy of the operating system in said partition.

Conveniently, the first address is a first local address.

The second address, from which the operating system is configured to run, may be the first local address.

Conveniently, the RAMdisk address is either the first local address or the second address.

Preferably the 4^{th} step comprises reconfiguring the hardware or software of the computer.

Preferably, the 4^{th} step comprises reconfiguring the computer so that the second address is treated as, or actually becomes, or was at installation of the operating system, the address of the RAMdisk.

The method may include configuring the computer's start up sequence to implement creation of the RAMdisk and copying of the operating system from the hard disk to the RAMdisk.

Creation of the RAMdisk may be performed by running a program operating in DOS. Alternatively the BIOS of the computer may be configured to create the RAMdisk before the computer starts any operating system.

In a preferred embodiment, the 4^{th} step is achieved through the use of a drive letter substitution means such as the DOS SUBST command.

Conveniently, where the second address was the first local address, the 4^{th} step is achieved through either hiding or deleting or removing the drive or partition at the first local address, or by hiding or deleting or removing a partition or a drive with an address different from the first local address, which has the effect of changing the first local address, and the RAMdisk is given the second address, the RAMdisk then having the correct address to run the operating system copy.

Alternatively, the step of creating the copy of the operating system at the first local address comprises installing the operating system on the hard disk and running a drive letter remapping program to create a copy of the operating system to be used on the Ramdisk, which copy is configured to be run from the second address. The drive letter remapping program preferably converts the drive codes (letters) of the instructions within the operating system files to the drive code (letter) to be assigned to the RAMdisk.

In an alternative embodiment an address substitution means such as the DOS SUBST command is used before the operating system is installed at the first local address, so that the computer has already relabelled the second address to be the first local address, and the address substitution is removed after the installation. In this way the operating system is configured to run from the second address but is in fact present at the first local address.

Changes made within the operating system during rung thereof from the RAMdisk may be copied back to the hard disk in order to preserve them for subsequent re-booting of the computer if desired. The step of copying back to the hard disk may be automated as part of the shutting down procedure and is preferably optional.

Preferably the method further includes the step of providing swapping means operable for allowing a user to swap backwards and forwards between running the operating system on the RAMdisk and running the operating system on the hard disk.

In a preferred embodiment, the method step of providing swapping means comprises the sub-steps of copying the operating system to a second hard disk or a hard disk partition and providing an address changing means.

Preferably, address changing means comprises means for instructing the computer to change the address of the RAMdisk and the hard disk, which address changing means does not require rebooting of the computer.

A software carrier as herein described is any medium capable of storing or carrying software code and may include a diskette or a CD or a data signal transmitted via a cable or via wireless means.

According to a second aspect of the present invention, there is provided a software carrier which, when run on a computer, is operative for configuring said computer to run an operating system from RAM, wherein the software comprises:

[1] means for creating a copy of the operating system on a hard disk at a first address, the operating system copy being configured to run from a second address;

[2] means for creating a RAMdisk having a RAMdisk address;

[3] means for copying the operating system copy from the hard disk to the RAMdisk; and

[4] means for reconfiguring the computer so that the second address, from which the operating system copy is configured to run is the RAMdisk address or is treated by the computer as being the RAMdisk address, so that said operating system copy can be run on the RAMdisk.

The software carrier may further include means for copying back the operating system to the hard disk so that changes made during running of the operating system from the RAMdisk are preserved for subsequent re-booting of the computer. The means may be operative for copying back to the hard disk as part of the shutting down procedure.

The software carrier may include a program for configuring the computer's start up sequence to implement said creating and said copying means. The software carrier may be a CD-ROM, a datastream, or any other electronic data carrying device.

The software carrier may include a program for configuring a swapping means in the computer, the swapping means being operable for allowing a user to swap backwards and forwards between running the operating system on the RAMdisk and running the operating system on the hard disk.

According to a third aspect of the present invention there is provided a computer comprising a hard disk, a CPU and RAM, characterised in that the computer further comprises:

a copy of an operating system installed on a hard disk at a first address, the operating system copy being configured to run from a second address;

means for creating in said RAM a RAMdisk having a RAMdisk address;

means for copying the operating system copy from the hard disk to the RAMdisk; and

means for configuring the computer so that the second address, from which the operating system is configured to run is the RAMdisk address or is treated by the computer as being the RAMdisk address, so that the operating system copy can be run from the RAMdisk.

Preferably, the computer further includes means for copying back the operating system to the hard disk so that changes made during running of the operating system from the RAMdisk are preserved for subsequent re-booting of the computer.

The means for copying back may be operative for copying back to the hard disk as part of a shutting down procedure.

The computer may include a program for configuring the computer's start up sequence to implement said creating and said copying means.

The computer may include a program for configuring a swapping means in the computer, the swapping means being operable for allowing a user to swap backwards and forwards between running the operating system on the RAMdisk and running the operating system on the hard disk.

According to a fourth aspect of the present invention, there is provided program code, executable by a computer comprising a hard disk, a CPU and RAM, said code operative for configuring the computer to run an operating system from RAM, said program code comprising:

[1] instructions for creating a copy of the operating system on the hard disk at a first address, the operating system copy being configured to run from a second address;

[2] a RAMdisk program for creating a RAMdisk having a RAMdisk address;

[3] a copy program for copying the operating system copy from the hard disk to the RAMdisk; and

[4] address changing means for reconfiguring the computer so that the second address, from which the operating system copy is configured to run is the RAMdisk address or is treated by the computer as being the RAMdisk address, so that the operating system copy can be run on the RAMdisk.

Preferably, the program code further includes a program for copying back the operating system to the hard disk so that changes made during running of the operating system from the RAMdisk are preserved for subsequent re-booting of the computer.

The program for copying back may be operative for copying back to the hard disk as part of a shutting down procedure.

Preferably, the program code includes a program for configuring the computer's start up sequence to implement said creating and said copying code.

The program code may include a program for configuring a swapping means in the computer, the swapping means being operable for allowing a user to swap backwards and forwards between running the operating system on the RAMdisk and running the operating system on the hard disk.

Embodiments have the advantage that the resulting copy of the operating system can be run from a RAM drive which has been assigned the predetermined address. In a preferred embodiment on the invention, the operating system is one of Microsoft Windows 95™, Microsoft Windows 98™, and OS/2™. More than one operating system can be installed on the same computer, a selected one being run from the RAM. In this case, each operating system is stored in a different designated area on the hard disk(s) and is operable from a drive having the predetermined address.

A further advantage of embodiments of the invention is the ability to swap from hard disk to RAMdisk operation without rebooting the computer. Typically, a swap can be made from hard disk to RAMdisk operation or vice-versa in about 10 seconds.

The capability to swap between hard disk and RAMdisk at will means that the system on the hard disk can be used to install programs and applications onto the hard disk (where they would normally be expected to reside), but the programs/applications can be run using the operating system on the RAMdisk (with all the corresponding performance advantages).

In general, in a preferred embodiment, the amount of RAM configured as a RAMdisk will be larger than the amount of RAM configured as program RAM for the computer. Preferably, the program RAM and the RAMdisk are directly addressable by the CPU through the RAM BUS. The contents of the RAMdisk are preferably mirrored on the hard disk of the computer to prevent loss of data when the system is switched off.

One embodiment utilises 750 MB of RAM with 500 MB configured as a RAMdisk and 250 MB configured as program RAM, a computationally intensive access Query will run around 2.5 times faster than it will on the same machine with 500 MB of program RAM and it will run around 4 or 5 times faster than the same machine with 750 MB of program RAM. In other words, all RAM above 500 MB should be configured as RAMdisk, and in fact all RAM above 250 MB is better configured as RAMdisk because the extra Program RAM between 250 MB and 500 MB has little positive effect (and no negative effect) on the performance of Microsoft Windows 95™ or 98™.

The present invention solves the problems enumerated [1] to [6] above by creating a RAMdisk in RAM, which is a virtual hard disk and is an area of RAM configured to function like a Hard Disk. The contents of the RAMdisk, which we call the Hyperdrive, are mirrored on a Hard Disk in the PC. When the PC is started a Program is run which can create a very large RAMdisk, of size greater than 100 MB. This disk is created before the Windows™ (or other large) operating system is started. A fast copying means is provided to copy the operating system from the Hard Disk mirror to the RAMdisk, before the operating system is started. In this way the volatility of the RAMdisk is overcome. Means may be provided for copying the contents of the RAMdisk back to the Hard Disk mirror, after the operating system has started and whilst it is running in and from the RAMdisk, whenever this is desirable.

Implementation of the invention may involve provision for extra RAM hardware to be installed in the PC, which is to be configured as the RAMdisk. This RAM is in addition to the typical 64 MB or 128 MB of program RAM used by the computer in its normal operations. Typically for running Microsoft Windows 95™ or 98™ on a RAMdisk, one would use at least 500 MB and 750 MB of extra RAM respectively.

Ideally one would use as much extra RAM as is possible given the Motherboard and current RAM stick configurations available, and the limitations of Windows.

To install a large operating system on the Hyperdrive, one copies a correctly addressed version of the operating system on to the Hard Disk Mirror, and then when the machine is restarted, have the operating system copied to the Hyperdrive before it is started. This process may require drive letter remapping, re-addressing, or specific addressing of the operating system installation of some sort by some means (this being the technical implementation of the invention).

Some operating systems, including Microsoft Windows 95/98™, experience instability and may otherwise crash/malfunction. So much so that the latter of the two has a Registry Checker program built in to the operating system to continuously monitor and hopefully correct any malfunctions that may develop during its operation. These problems are to a large extent solved in embodiments of the present invention by running the operating system from the RAMdisk, which we call the DMP Hyperdrive (Disk Mirrored Program Hyperdrive). This is because each time the computer is started it uses the virgin copy of the operating system that was originally installed. In this way even if the operating system malfunctions during a session, the malfunction will be lost when the computer is turned off. When the computer restarts, the original virgin version of the operating system is restored from the Hard Disk mirror. In this way the problem is not only cured, but in fact as far as the computer is concerned it never even existed!

The best that the Registry Checker can do is to correct any malfunction that the operating system may have developed during a session, and then restart the machine with this correction. But when the operating system is running from the Hyperdrive, it restarts from the perfect uncorrupted and unused original installation of the operating system, so the computer restarts as if the malfunction had never occurred. When Windows™ is running on a hard disk, some malfunctions are so bad that they cause the operating system to be irreversible damaged, so that it needs to be re-installed.

This does not happen when Windows™ is running in RAM on a Hyperdrive, one just goes back to the beginning of the session and starts again.

So, in particular, the Microsoft Windows 95™ and Microsoft Windows 98™ operating systems are loadable on to a Hyperdrive with this invention. Something which is completely unknown when they are running from hard disks, which remember all of the malfunctions of the previous computing session. It could in fact be argued that the Windows 98™ Registry Checker Program is half way to what the Hyperdrive automatically achieves.

Since the Hyperdrive is so fast, every program running in Windows™, such as Microsoft Word or Internet Explorer loads almost immediately.

Typically, Microsoft Office programs, such as Word, Access etc. installed on the Hyperdrive run several times faster than they would had they been installed on a Hard Disk. However this difference will only be noticeable in the case of programs which take a few minutes to run and in cases where the hard disk is unable to keep up with the CPU in the case of Hard Disk Operation. In these cases the slowest commercially available Windows™ 9x PC today, the 400 MHz Pentium II machine, will run Microsoft Windows™ and Microsoft Office faster on a DMP Hyperdrive than the fastest commercially available Windows™ 9x PC today (1.2 GHz AMD Athlon Machine). This is because it has an IO (Input/Output) advantage over any hard disk of at least 20 times. However modern UDMA 5 ATA100 hard disks can keep up with most Microsoft Office programs.

If, on the other hand a DMP Hyperdrive is fitted to the fastest Windows™ 9x machine available today, then you have a rocket, a true electronic computer rather than a magnetic abacus. And more importantly you have an instant desktop. So the time taken by the operator to set up his programs to run is reduced purely to his thinking time. He will never have to wait for a window to open or close. This sort of large speed advancement was last achieved in 1995 by Microsoft Windows 95™, which ran programs many times faster than its predecessor, Microsoft Windows™ 3.1 did on the same computer.

Embodiments of the present invention will now be described by way of example, with reference to the drawings in which:

FIG. 1 is a schematic diagram showing a configuration common to most of today's PCs;

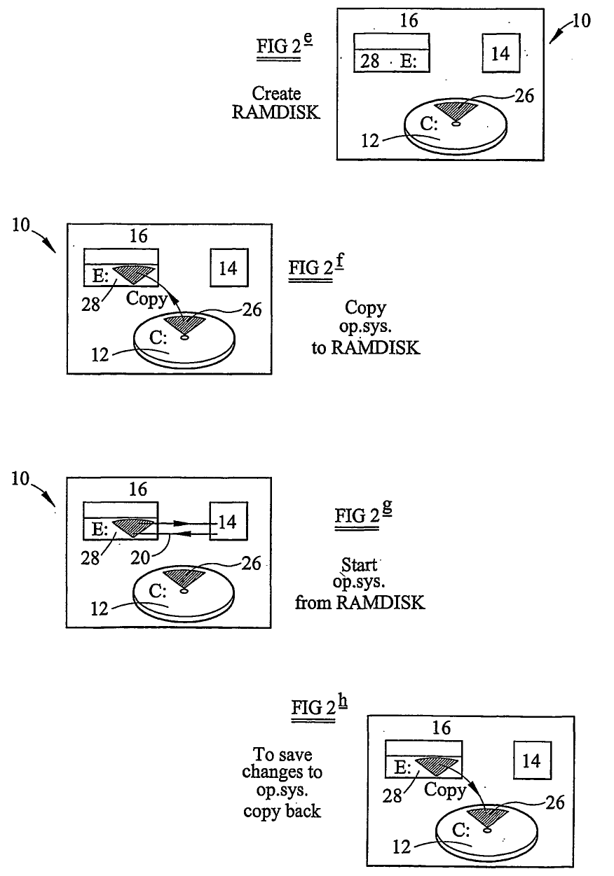

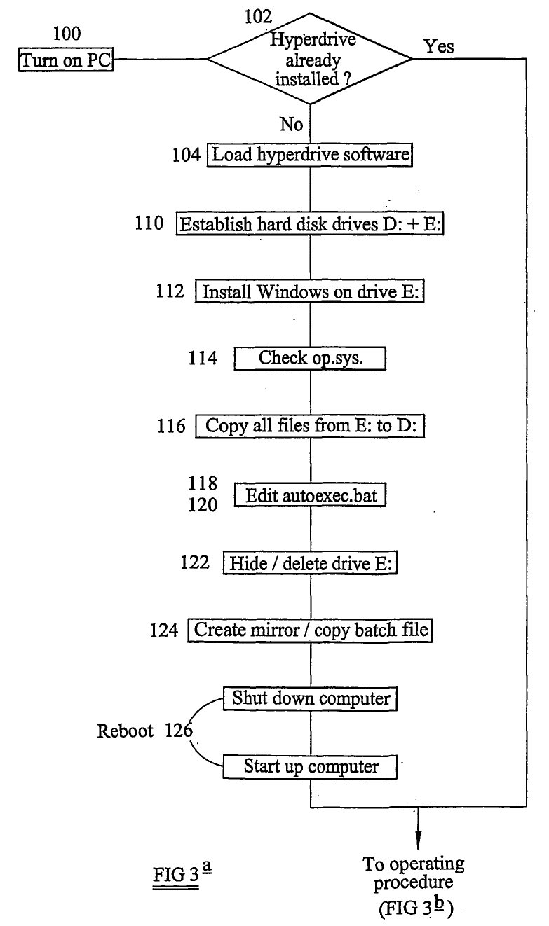

FIGS. 2a to 2h show a series of diagrams similar to that of FIG. 1, illustrating the stages of a procedure for implementing and operating a large operating system (Windows 95™ or 98™) in and from a RAMdisk;

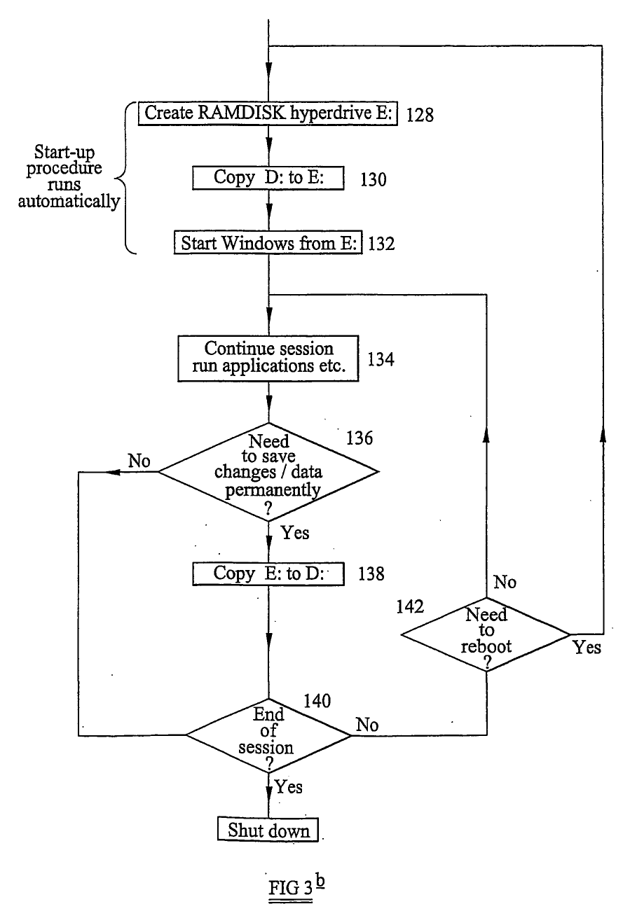

FIG. 3a is a flow chart illustrating the implementing procedure of FIGS. 2a to 2d;

FIG. 3b is a flow chart illustrating the operating procedure of FIGS. 2e to 2h; and

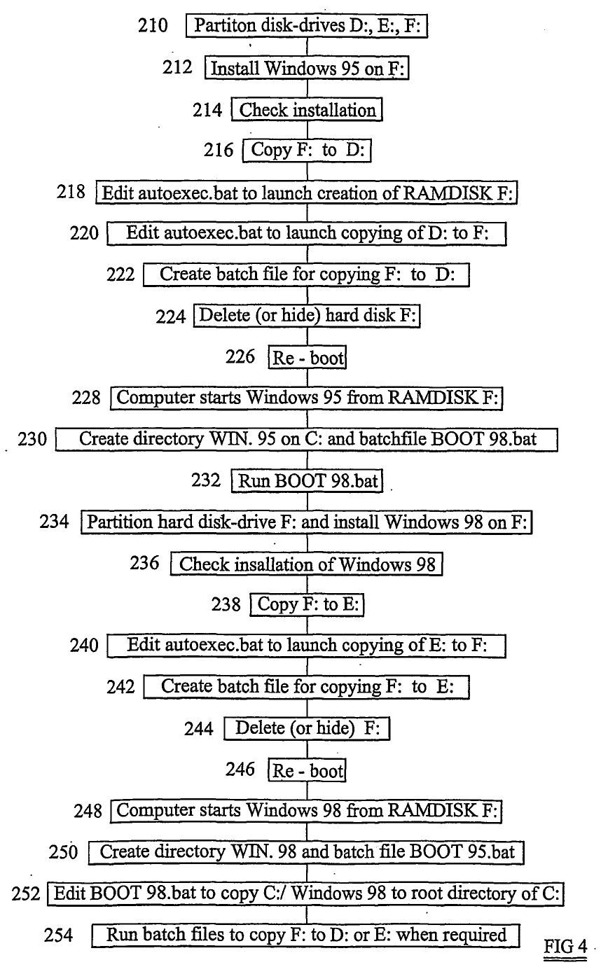

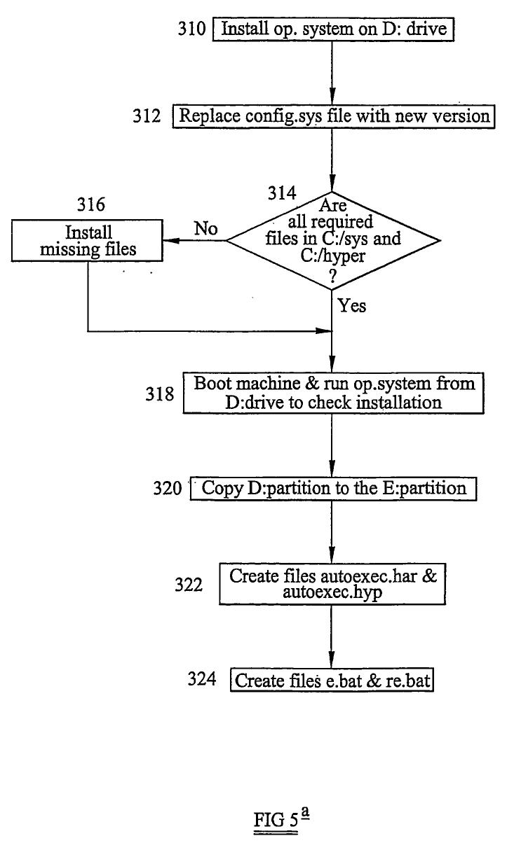

FIG. 4 is a flow chart illustrating the stages of a procedure for implementing and operating one of two (or more) large operating systems in and from a RAMdisk.

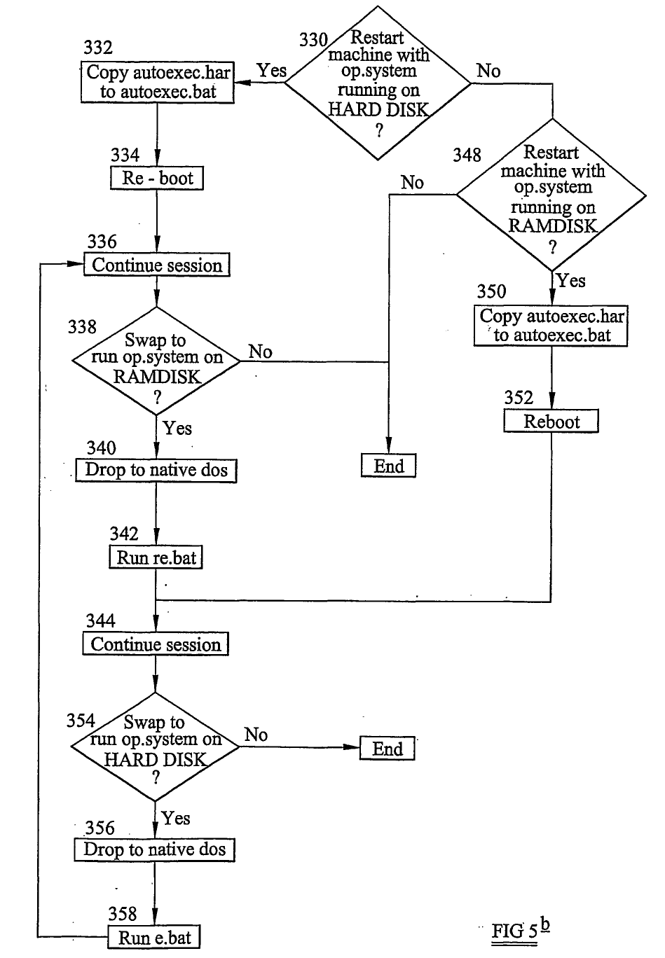

FIG. 5a is a flow chart illustrating the implementing procedure of a preferred embodiment; FIG. 5b is a flow chart illustrating the operating procedure of the preferred embodiment.

The most general method of configuring a stand alone or a networked computer (PC) to run a large operating system from and in RAM, where A, and C are local addresses to the PC, and B is an address which may or may not be local to the PC is as follows:

[1] Create a copy of the operating system at address A, configured to run from address B (where B may or may not be A);

[2] Install a RAMdisk at address C (where C may or may not be A or B);

[3] Copy the operating system to the RAMdisk

[4] If necessary, reconfigure or readdress the software or hardware or firmware or BIOS or other component or components of the PC so that Address B from which the operating system is configured to run (which may or may not be Address A, where the operating system copy was created), is treated as, or actually becomes Address C, where the RAMdisk is installed.

Note that there is no need to further reconfigure the operating system copy to run from Address C, this flexibility is already provided by address B. Also, you cannot copy after the readdressing because A might be C.

[5] Start the operating system on the RAMdisk

In a preferred embodiment Address A is an address on a hard disk.

Referring to FIG. 1, a PC 10 contains a hard disk 12 having a disk drive designation C:, a CPU 14 and RAM 16. Hard disk 12 communicates with CPU 14 via a hard disk BUS 18 and CPU 14 communicates with RAM 16 via a RAMBUS 20.

### [A] Means for Installing Microsoft Windows 95™ or 98™ on a RAMdisk

The following component programs are required.

[1] A program which can create a large (Greater than 100 MB) RAMdisk ‘The Large RAMdisk Program’ The program that the inventor has used is XMSDSK.exe version 1.9, written by Franck Uberto of Grenoble France. It is available as shareware on the internet, the filename is fu_rd19i.zip. If you search at www.google.com for “xnsdsk” you will find many appropriate sites from which to download this program. The RAMdisk program works by configuring some of the computer's RAM to have precisely the same parameters as those used by MS DOS for the Hard Disk.

[2] A program which will quickly copy an entire operating system between a Hard Disk and the RAMdisk in both directions, ‘The Fast Copying Program. The Fast copying means used is HDCP.exe version 3.1 for batch files, which was written by Chang Ping Lee of Palo Alto Calif. and is available at a price from DCF software, P.O. Box 60065 Palo Alto Calif. USA. You can download a shareware version of this program, which is not the preferred version at this time because it is full of adverts, from many internet sites. Just search for hdcp31 and download the file hdcp31.zip from one of the appropriate resulting sites. HDCP is a sector by sector hard disk copying program. We have found that this sector by sector copying method and in particular this program is the fastest copying means for the present invention. However one can use other copying means such as LCOPY.exe with the appropriate switches, a longfilename disk copying program also available as shareware on the internet (do a search for LCOPY and download from any of the appropriate sites found). Any copying means which transfers all of the information (including long file names, hidden, system and read only files) to and from the Hard Disk mirror from and to the Hyperdrive will do.

[3] An address changing or re-addressing or address redirecting means. This can be a drive letter remapping or a drive letter substituting or a drive letter changing or a drive letter hiding or a drive letter unhiding or a drive or drive letter adding/removing means. Alternatively, it can be a directory renaming means. We will call this the ‘address changing means’.

This means can be as crude as unplugging a hard disk or as elegant as the DOS “SUBST.EXE” program or the DOS “REN” command.

The invention has been successfully implemented for both Microsoft Windows 95™ and Microsoft Windows 98™. The RAMdisk program and the fast copying means are both DOS operating system programs, and are run from the DOS Autoexec.bat file. Typically, one would store the operating system and most of the Windows™ compatible programs on the Hyperdrive. This would mean that the Hyperdrive would be at least 500 MB in size for MS Windows 95™ and programs and at least 750 MB in size for MS Windows 98™ and programs. The maximum size that MS Windows™ 9x can address is 4 GB. This extra RAM needs to be installed in the motherboard of the PC.

If you create a large RAMdisk with the Large RAMdisk Program and then try to install Windows 95™ or Windows 98™ on to it, you will fail because both of these programs force the computer to restart automatically during the installation. When the computer restarts it loses all of the information on the Large RAMdisk.

If instead: you install Microsoft Windows 95™ or 98™ on what is technically called the boot partition of your Hard Disk, and which is generally called your ‘C drive’, but which in many cases is simply ‘your hard disk’; next you copy it to the RAMdisk using the Fast Copy Program; next you delete it from the Hard Disk where you installed it; next you tell the computer that the operating system is no longer on the hard disk at address ‘A’ but has moved to the Ramdisk at address ‘B’, then the operating system will not run on the RAMdisk because when it needs to run one of it's components it will expect to find that component not on the RAMdisk at address ‘B’, where the component now resides, but rather on the Hard Disk at address ‘A’ where that component was first installed. As a result the operating system will not work.

The solution to this problem is not to install the RAMdisk on your computer as yet, but instead to follow the steps illustrated in FIGS. 2a to 2h. Corresponding numerals refer to the same components in FIG. 1 and FIGS. 2a to 2h. As shown in FIG. 2a, the first step is to install a second hard disk on your computer, or to use a hard disk configuring program such as Partition Magic by Powerquest Software, which creates a second hard disk 22 from a part of your first hard disk 12.

When creating the second hard disk 22 one has to ensure that the address of this second hard disk 22 is the same address (E:) that the computer will finally give to the RAMdisk when it is installed. As shown in FIG. 2b, one then installs Microsoft Windows 95™ or 98™ 24 on this second hard disk 22, with the same address (E:) that the RAMdisk will eventually have. When the operating system is finally placed on the RAMdisk and it looks for one of it's components at the address which this component had when it was first installed on the second hard disk, it will actually find this component on the RAMdisk at that very address.

Note that when you create a partition on a hard disk (or on a RAMdisk), which, for example, you designate your E:drive, and you are susbsequently going to rename another drive as your E: drive, you must ensure that both the old and new drives have the same Volume Serial Number. This is because, if the Volume Serial Numbers are not the same, some operating systems (such as Windows™ 98) will automatically assign another drive letter to the old E:drive, and relabel the addresses of all other drives in alphabetical sequence, upsetting the drive letter sequencing and filename pathways.

As shown in FIG. 2c, one then copies this entire installation to the first hard disk (C:) 12, to create a system copy 26. As shown in FIG. 2d one then removes (deletes or hides) the second hard disk 22 using the hard disk configuring program. Then, the computer is turned off. At this point we have a version of Microsoft Windows 95™ or 98™ that is properly addressed for the RAMdisk, in that it expects to find itself at the location where the RAMdisk will be. So this version will run on a RAMdisk, but we still haven't actually put it on one or run it on one as yet.

Putting this more technically: the address of the first hard disk 12 is the ‘C drive’, the address of the second hard disk 22 is the ‘E drive’, and the address of the RAMdisk will eventually also be the ‘E drive’. So one installs Microsoft Windows 95™ or 98™ 24 on the E drive, when it comprises the second hard disk 22. One then copies this installation to create a system copy 26 on the C drive 12. One then preferably turns the computer off and removes the second hard disk 22, and we will in the next phase of this operation create a large RAMdisk in such a way that the computer will call it the ‘E drive’, the name/address that it used to give to the second hard disk 22, before it was removed.

To summarize, the steps are:

FIG. 2a create a second hard disk 22

FIG. 2b install Windows 95™ or 98™ 24 on this second hard disk 22

FIG. 2c make a copy 26 of this installation to the first hard disk 12

FIG. 2d remove the second hard disk 22.

### [B] Means for Loading Microsoft Windows 95™ or 98™ From a RAMdisk

Having completed section [A] one has a copy of the good installation of Windows™ on the first hard drive 12. When the computer is turned on again one needs to create the RAMdisk with the Large RAMdisk Program and copy the good installation from the Hard drive to the RAMdisk using the Fast Copying Program before the computer needs any part of this installation. When the computer starts or boots, a message: Starting Windows 95™ or Starting Windows 98™ appears. But despite this message from Microsoft, this is not when it actually starts these programs. Instead it starts the version of DOS underneath Windows™ at that time.

These versions of DOS, once they are started, themselves start the respective versions of Windows™ by running a program called WIN.COM.

Thus the computers start up sequence needs to be configured so that, as shown in FIG. 2e, these versions of DOS first run the Large RAMdisk Program to create the RAMdisk 28. As shown in FIG. 2f the start up sequence then runs the Fast Copying Program to copy the good installation of Windows™ 26 from the hard disk 12 to the RAMdisk 28 before the Windows™ operating system truly is started. Then, as shown in FIG. 2g DOS starts Windows™ from the RAMdisk 28.

To summarize, the steps that the computer goes through at start up are:

Start the appropriate version of DOS

FIG. 2e Create the Large RAMdisk 28, with the Large RAMdisk Program

FIG. 2f Copy the good installation 26 from the hard disk 12 onto the RAMdisk 28 with the Fast Copying Program

FIG. 2g DOS Starts running Windows™ from the good Windows™ installation now on the RAMdisk 28

We had to perform and program the computer to perform all of the above steps in [A] and [B] to make a computer run Microsoft Windows 95™ or 98™ from a RAMdisk the first time we did it. This whole process, although each individual step is known to some computer professionals, is logically quite complex. It also uses two programs, the Large RAMdisk Program and the Fast Copying Program, neither of which are made by Microsoft or any well known software company and neither of which is available in any high street. In fact both programs, which are excellent, appear to have been written by one man bands. This may be why no one has succeeded in doing this before.

Having created a version of Microsoft Windows™ which is property addressed for the RAMdisk and having stored it on a hard drive, one does necessarily not have to go through this whole process again for the next computer upon which one wishes to run Windows™ from a RAMdisk. If this second machine is similar to the first machine, then one can simply copy the version of Windows™ from the first machine to the hard disk of the second machine (subject to the Microsoft Windows™ Licence).

The above 8 step process can be shortened to the following basic steps:

[1] Install Windows on a Hard disk at a first address

[2] Install the large RAMdisk designating it a second address

[3] Copy windows from the Hard disk to the RAMdisk

[4] Re-address the RAMdisk so that now has the first address and the windows installation on the hard disk no longer has this address.

[5] Start Windows on the RAMdisk.

This can be done as follows:

[1] Install windows on the D: drive in the directory D:\windows

[1a] Start this version of Windows and then drop to DOS

[2] Run the large RAMdisk program xmsdsk.exe to create a 400 MB RAMdisk at drive letter E:

[3] Use the fast copying means to copy the windows installation from the D: drive to the E: drive

[4] Use the DOS “SUBST” command to rename the D: drive as the E: drive as follows:

c:\sys\subst d: e:\
assuming that the “subst.exe” program is in the c:|sys directory.
[5] Run windows by typing ‘exit’.

The “subst” command effectively hides the real D: drive and tells the computer that D: is in fact the E: drive. The computer will ‘think’ that it is restarting the version of windows on the Hard disk, but it will in fact be starting the version on the RAMdisk.

### [C] Means for Running and Saving Programs and Applications for Microsoft Windows 95™ and 98™ on a RAMdisk.

If during a Windows™ session, one installs a new program or one changes a parameter, in either Windows™ or a program running in Windows™ and one wishes to keep the result. Then, as shown in FIG. 2h the Fast Copying Program can be used to copy that configuration of the operating system from the RAMdisk 28 back to the hard disk 12, to be used the next time that the computer is started. This can be done manually when desired or automatically when desired.

Referring now to FIG. 3a, the procedure for installing Windows™ 95 from a RAMdisk is described.

We assume that the C: drive is the boot drive. For other boot drive letters the appropriate drive letter should be substituted.

The embodiment describes running Microsoft Windows™ 95 using 750 MB of RAM with 600 MB configured as a RAMdisk by xmsdsk.exe version 1.9. We used a partition of 2 GB with drive letter D: as the Hard Disk Mirror, and the RAMdisk was given the drive letter E:.

After turning on the computer at step 100, then at step 102, if a Hyperdrive capability has not already been installed, the installation software is loaded at step 104 and installation proceeds as follows:

Step 110 Create a 2 GB FAT16 hard disk petition with drive letter D: using a hard disk partitioning program such as Partition Magic by Powerquest Software. Then create a second 2 GB FAT16 hard disk partition with the drive letter E: using the same software.

Step 112 Install Microsoft Windows 95™ on this partition by selecting E:\WINDOWS rather than C:\WINDOWS in the installation procedure.

Step 114 Boot the machine and run Windows 95™ from this hard disk partition to make sure that it has been properly installed (you can check the installation with a program such as Norton Utilities if you desire).

Step 116 Use HDCP version 3.1 to copy the E: drive to the D: drive. This places the operating system on the D: drive which is the Hard Disk Mirror

Step 118 Edit the Autoexec.bat file to include a line launching the 600 MB RAMdisk with xmsdsk.exe version 1.9 with the drive letter E:

Step 120 Edit the autoexec.bat file to include a line launching the fast copying means (HDCP.exe version 3.1), to copy the D: drive to the E. drive (which will be the RAMdisk)

Step 122 Delete or Hide the Hard Disk partition that you installed Windows™ on, with drive letter E:

Step 124 Create a batch file which copies/mirrors the contents of the RAMdisk, the Hyperdrive, the E: drive, back to the Hard Disk Mirror, the D: drive. You can use this whenever you install new programs on the RAMdisk, the Hyperdrive, or whenever you change the settings of these programs or of Windows™ and wish to preserve the result for the next Windows™ session. The batch file should preferably run in Native DOS Mode, i.e. true or real DOS mode. It can also run in a DOS shell under Windows™ but this may cause trivial registry problems for Windows™ (Word 2000 is particularly susceptible to this).

Step 126 Reboot.

If, at step 102, the Hyperdrive had already been installed, then starting up the computer will proceed to the operating procedure of FIG. 3b, which will execute automatically.

Step 128 Now the computer will start and the RAMdisk will be created.

Step 130 The Windows™ installation which was done on the E: drive will be copied to the RAMdisk which is also given the drive letter E: so that when the operating system looks for files on the E: drive, they will actually be there, although in this case in the RAMdisk rather than on the Hard Disk partition where they were installed.

Step 132 Windows 95™ starts from the RAMdisk.

Step 134 Proceed with your computing session.

Step 136 During a session, when you install programs on the Hyperdrive that need to restart the computer during the installation, be sure to leave the restart option window and, at step 138, run the batch file to Mirror the Hyperdrive to the Hard Disk before you restart the computer at step 142, otherwise you will lose the current installation since the Hyperdrive is a volatile drive. Similarly, at the end of a session if you wish to preserve any changes made to system or data files on the Hyperdrive, be sure to run the copy/mirror batch file before exiting at step 140.

In another embodiment, running Microsoft Windows 98™ we used 750 MB of RAM with 600 configured as a RAMdisk by xmsdsk.exe version 1.9. We used a partition of 2 GB with drive letter D: as the Hard Disk Mirror, and the RAMdisk was given the drive letter E:.

The installation works as for Windows 95™ described above, but there were two technical problems that we encountered here. Firstly Windows 98 is a lot more temperamental than Windows 95 in our experience. It is advertised as being more stable, and faster the 95, but in our experience it is neither. Windows 98 needs to have the lower memory addresses, the first bit of memory for itself. So the RAMdisk program should be configured to take the higher memory addresses. In other words if one has 750 MB installed and one has a 600 MB RAMdisk, then rather than the RAMdisk taking the first 600 MB of the RAM, it could take the last 600 MB of memory. Alternatively it could take all memory above a certain level say, 16 MB, 32 MB 64 MB, 128 MB etc.

Secondly you may need to turn off the Microsoft Windows 98 Registry Checker Program because when Windows is started on a RAMdisk, neither Windows nor the RAMdisk exists until the RAMdisk is created, and the RAMdisk is created after the Windows registry is checked. So the registry is checked, in it's use as a surrogate DOS start up program before it exists. This can cause the registry checker program to kick in and ruin your Windows installation. In any case, the function of the Windows Registry Checker is carried out better by the Hyperdrive's volatility.

### Microsoft Office Programs and Internet Explorer Upgrades

The simplest way to install Microsoft Word, Access, Excel, Frontpage and newer versions of Internet Explorer than those provided with the operating system and other Microsoft Office programs is to do it just after MS Windows™ is installed on the hard disk. That is to install them immediately after step [3] above. In this case the programs install just as they would normally. Then steps [4] onwards install the operating system and the Microsoft Office programs on to the Hyperdrive, for dramatic performance advantages. These programs can also be installed directly on to the Hyperdrive at a later date as described in steps 124 and 136 of FIG. 3.

### Other Embodiments

Rather than mirroring the Hyperdrive to a hard disk partition, one can mirror the whole drive to one file which can be stored anywhere on the hard disk. HDCP version 3.1 can do this. Such a file is called an image file. This process is slightly slower than using a partition as a mirror and exerts more strain on the hard disk and so is not so preferable from the performance standpoint. But it is more convenient to set up.

Rather than creating a hard disk partition with the drive letter that will eventually be used by the RAMdisk (E:), and installing the software in this partition and then copying it to the hard disk mirror partition, with the drive letter D:. One can directly install it in the hard disk mirror partition itself and then use a drive letter remapping program such as the one provided with Partition Magic version 6, by Powerquest. This changes all references to the drive letter D: in the operating system to be references to the drive letter E: instead, for example.

One could even reconfigure an existing installation of Windows™ to run on the Hyperdrive, by using a drive letter remapping program as described above. If Windows™ is installed on the C: drive, then the drive letter remapping program can change this to the E: drive. Windows™ will then run on the Hyperdrive, when copied there. In this way Windows™ does not have to be re-installed. We do not prefer this embodiment because it uses a ‘second-hand’ version of Windows™, one that has been used many times before, so it may be less reliable than a virgin copy. Although this method has convenience advantages.

### Drive Substitution Embodiment

One can change the drive letter of a Hard Disk with the DOS “SUBST” command. To remap the drive letter D: to refer to the drive E: one uses the command line

### SUBST D: E:\

This technique tells the computer to regard one drive as another drive. In computer parlance one is creating a ‘virtual drive’. This method can be used both to install Windows with the correct address references and to run Windows both from a RAMdisk and from a Hard Disk Mirror. The steps for installing Windows 95 are as follows:

Assuming that the C: drive is the boot drive. (For other boot drive letters please substitute the appropriate drive letter(s).)

In the preferred embodiment, running Microsoft Windows 95 we used 750 MB of RAM with 600 configured as a RAMdisk by xmsdsk.exe version 1.9. We used a partition of 2 GB with drive letter D: as the Hard Disk Mirror, and the RAMdisk was given the drive letter E: . The installation works as follows:

[1] Clean boot your computer from a windows 95 or 98 startup disk. Copy the Subst.exe program to the c:\sys directory of your hard disk. Tell the computer that the D: drive is in fact the E: drive using the command: c:\sys\subst e: d:\

[2] Install Microsoft Windows 95 on the D: drive by installing it to E:\WINDOWS rather than C:\WINDOWS in the installation procedure. This virtual E: drive is in fact the D: drive, but the files on it believe that they are on the E: drive, since this is how the computer is addressing the D: drive by means of the ‘Subst’ command above. You will get a warning from Microsoft that this may not work, but Microsoft allow you continue anyway. Ignore the warning—it works subject to [2a]

[2a] Ensure that there are no other Windows directories anywhere on your computer, and at the first reboot in the Windows installation procedure, reinsert the windows 95 start up disk and return to DOS. Then replace the config.sys and autoexec.bat files that Windows has created with the following files:

Config.sys
Device=c:\sys\himem.sys
Device=c:\sys\ifshlp.sys
Device=c:\sys\dblbuff.sys
Device=c:\sys\setver.exe
Autoexec.bat
c\sys\subst e: d:\
path=%path%

Make sure that the 4 files: Himem.sys, Ifshlp.sys, dblbuff.sys and setver.exe are in the c:sys directory of your hard drive. This effectively wrests control of the start up from the Windows Registry (which may not exist at boot up in the case of booting to the Hyperdrive) and hands it over to DOS. The path command in the autoexec.bat file is placed there so that the computer shows you what it thinks it is doing as regards addresses. Although Windows can recognise a ramdrive, and uses a memory chip as an icon for the ramdrive in cases where Windows is running from a hard disk, it cannot believe that it itself could be actually running in RAM, so it uses a Hard Disk icon in cases where it is running from a RAMdisk!

Having replaced these two files then reboot back into the windows installation procedure, and finish the procedure.

[3] Boot the machine and run Windows 95 from this hard disk partition to make sure that it has been properly installed (you can check the installation with a program such as Norton Utilities if you desire—although in our experience it doesn't help at all). If you look at the Msdos.sys file using the command:

Edit msdos.sys (it is a hidden file, and can be seen with the edit or with attrib commands)

WinDir=E:\WINDOWS

WinBootDir=E:\WINDOWS

HostWmBootDrv=E

The computer is set up to find and boot Windows from the E: drive. Remember, there is no E: drive on your computer, you have merely renamed the D: drive as the E: drive.

[4] Edit the Autoexec.bat file to include a line launching the 600 MB RAMdisk with xmsdsk.exe version 1.9 with the drive letter E:

[5] Edit the autoexec.bat file to include a line launching the fast copying means (CP.exe version 3.1), to copy the D: drive to the E: drive (which will be the RAMdisk)

[6] Reboot. (not strictly neccessary but preferable)

[7] Now the computer will start and the RAMdisk will be created and then the Windows installation which was done on the D: drive which was badged as the E: drive using the SUBST command will be copied to the RAMdrive which is also given the drive letter E: so that when the operating system looks for files on the E: drive, they will actually be there, although in this case in the RAMdisk rather than on the Hard Disk partition where they were installed.

[8] Create a batch file which copies/mirrors the contents of the RAMdisk, the Hyperdrive, the E: drive, back to the Hard Disk Mirror, the D: drive. You can use this whenever you install new programs on the RAMdisk, the Hyperdrive, or whenever you change the settings of these programs or of windows and wish to preserve the result for the next Windows session. The batch file should preferably run in Native DOS Mode, i.e. true or real DOS mode. It can also run in a DOS shell under Windows but this may cause trivial registry problems for Windows (Word 2000 is particularly susceptible to this).

[9] When you install programs on the Hyperdrive that need to restart the computer during the installation, be sure to leave the restart option window and run the batch file to Mirror the Hyperdrive to the Hard Disk before you restart the computer, otherwise you will lose the current installation since the Hyperdrive is a volatile drive. However installing things on the Hyperdrive is not preferred. It is better to swap back to hard disk operation and install them there.

[10] To swap back to hard disk operation you need to do the following:

[a] Drop to DOS

[b] Edit the autoexec.bat file, rem out the line creating the RAMdisk (or change it's drive letter to be say F:)

[c] Edit the autoexec.bat file, rem out the line copying the D: drive to the RAMdisk

[d] Insert the drive letter substitution line: c:\sys\subst e: d\:

Then reboot. Now windows, which is set up to run on the E: drive. will be running on the E: drive, but this drive, rather than being the Hyperdrive will now be the Hard Disk Mirror, the D: drive.

In another embodiment, the operating system can be run from the hard disk drive or from the RAMdisk and the user may swap between the two without the need to reboot the computer

An operating system copy is created at a first predetermined drive code (address) and is configured to run from a second predetermined drive code (which may or may not be the first predetermined drive code). The operating system is the copied to a hard disk or hard disk partition having a third predetermined drive code and to the RAMdisk having a fourth predetermined drive code.

Using the DOS “subst” command or similar means, if the computer is told that the second predetermined drive code is in fact the third predetermined drive code, then it will run the operating system from the hard disk. If, on the other hand, it is told that the second predetermined drive code is in fact the fourth predetermined drive code, then it will run the operating system from the RAMdisk.

In this way, by sequentially telling the computer that the second predetermined drive code is in fact one or the other of the third or the fourth predetermined drive codes, the computer can be made to run the operating system from the hard disk or RAMdisk at will.

For technical reasons it has been found preferable to leave the operating system copy created on the hard disk with the first predetermined drive code but configured to run from a second predetermined drive code (that may or may not be the first predetermined drive code) in place. This place is termed the anchor partition if it is a partition.

The capability to swap between hard disk and RAMdisk at will means that the system on the hard disk can be used to install programs and applications onto the hard disk (where they would normally be expected to reside), but the programs/applications can be run using the operating system on the RAMdisk (with all the corresponding performance advantages).

### Bios Controlled Hyperdrive

One can also configure the BIOS of a computer to install the Hyperdrive before boot up, i.e. before the computer starts any operating system, and to copy it to the hard disk mirror at shut down if such copying is required

### Hyperdrive or Hard Disk Operation

Having installed Windows™ on the second Hard Disk, one can ‘hide’ this hard disk from the Operating system, rather than removing it. This can be done with PowerQuest's Partition Magic Program or the likes. In this way the Second Hard Disk (or Hard Disk Partition) is still configured to run Windows™. This gives one the option to return to running Windows™ on a Hard Disk, rather than on a Hyperdrive, if one desires, by unhiding this second Hard Disk (or Hard Disk Partition), restarting the computer and not running the Large RAMdisk Program after this restart. Windows™ will then simply run on the second hard disk upon which it was installed. To return to running Windows™ on the Hyperdrive one hides the second hard disk and restarts the computer again but this time one does run the Large RAMdisk Program after start up and before the Fast Copying Program copies Windows™ from the Hard Disk Mirror to the RAMdisk. By automating these two processess, the computer can be set up to offer the user the option to restart either running Windows™ on the Hyperdrive or running Windows™ on the Hard Disk. This will be useful for those who are insecure about the Hyperdrive, when they first use it

### Mult Operating System Hyperdrive

This invention can easily be configured to run several operating systems, such as Microsoft Windows 95™, Microsoft Windows 98™, Microsoft Windows™ 3.1 all on the same computer. One simply installs the first operating system on the Hyperdrive and then copies the system to the Hard Disk Mirror as System1. Then one installs the next operating system on the Hyperdrive and copies it to the Hard Disk Mirror as System2 etc. Then at start up, one can choose which one of the various mirrored operating systems to copy back from the Hard Disk Mirror to the Hyperdrive. This operating system will then run on the Hyperdrive during the next computing session.

Referring to FIG. 4, the steps for configuring dual and multiple operating systems are described.

We assume that the C: drive is the boot drive. For other boot drives substitute the appropriate drive letter(s).

Step 210 Create a 2 GB FAT16 hard disk petition with drive letter D: using a hard disk partitioning program such as Partition Magic by Powerquest Software. Then create a second 2 GB FAT16 hard disk partition with the drive letter E: using the same software. Then create a third 2 GB FAT16 hard disk partition with the drive letter F: using the same software.

Step 212 Install Microsoft Windows 95™ on the partition with drive letter F: by selecting F:\WINDOWS rather than C:\WINDOWS in the insallation procedure.

Step 214 Boot the machine and run Windows 95™ from this hard disk partition to make sure that it has been properly installed (you can check the installation with a program such as Norton Utilities™ if you desire).

Step 216 Use HDCP version 3.1 to copy the F: drive to the D: drive. This places the operating system on the D: drive which is the Hard Disk Mirror for Windows 95™.

Step 218 Edit the Autoexec.bat file to include a line launching the 600 MB RAMdisk with xmsdsk.exe version 1.9 with the drive letter F:

Step 220 Edit the autoexec.bat file to include a line launching the fast copying means (HDCP.exe version 3.1), to copy the D: drive to the F: drive (which will be the Ramdisk)

Step 222 Create a batch file which copies/mirrors the contents of the RAMdisk, the Hyperdrive, the E: drive, back to the Hard Disk Mirror, the D: drive. You can use this whenever you install new programs on the RAMdisk, the Hyperdrive, or whenever you change the settings of these programs or of Windows™ and wish to preserve the result for the next Windows™ session. The batch file should preferably run in Native DOS Modes, i.e. true or real DOS mode. It can also run in a DOS shell under Windows™ but this may cause trivial registry problems for Windows™ (Word 2000 is particularly susceptible to this).

Step 224 Delete or Hide the Hard Disk partition that you installed Windows™ on, with drive letter F:

Step 226 Reboot.

Step 228 Now the computer will start and the RAMdisk will be created and then the Windows™ installation which was done on the F: drive will be copied to the Ramdrive which is also given the drive letter F: so that when the operating system looks for files on the F: drive, they will actually be there, although in this case in the RAMdisk rather than on the Hard Disk partition where they were installed. Note that this step encompasses all the equivalent steps 128, 130 and 132 of FIG. 3.

Step 230 Create a directory on the C: drive called Win95. Create a batch file called Boot98.bat which copies the all the files, including the system files the hidden files and the read only files from the root directory of the C: drive to the Win95 directory, using say Microsoft's XCOPY.exe (from MSDOS7×) with/h/k switches, and then erases all files from the root directory of the C: drive. For the deletion one can use:

Attrib -s -h -r C:\*.*
Del C:\*.*

Alternatively use other copying means which can copy all hidden files read only files and system files. Specifically it must copy at least IO.SYS, MSDOS.SYS, COMMAND.COM, CONFIG.SYS, AUTOXEC.BAT.

Step 232 Run the batch file Boot98.bat.

Step 234 Install Microsoft Windows 98™ on the partition with drive letter F: by selecting F:\WINDOWS rather than C:\WINDOWS in the installation procedure.

Step 236 Boot the machine and run Windows 98™ from this hard disk partition to make sure that it has been properly installed (you can check the installation with a program such as Norton Utilities™ if you desire).

Step 238 Use HDCP version 3.1 to copy the F: drive to the E: drive. This places the operating system on the E: drive which is the Hard Disk Mirror for Windows 98™.

Step 240 Edit the autoexec.bat file to include a line launching the fast copying means (HDCP.exe version 3.1), to copy the E: drive to the F: drive (which will be the RAMdisk)

Step 242 Create a batch file which copies the contents of the RAMdisk, the Hyperdrive, the F: drive, back to the Windows 98™ Hard Disk Mirror, the E: drive. You can use this whenever you install new programs on the RAMdisk, the Hyperdrive, or whenever you change the setting of these programs or of Windows™ and wish to preserve the result for the next Windows™ session.

Step 244 Delete or Hide the Hard Disk partition that you installed Window™ on, with drive letter F:

Step 246 Reboot.

Step 248 Now the computer will start and the RAMdisk will be created and then the Windows™ installation which was done on the F: drive will be copied to the Ramdrive which is also given the drive letter F: so that when the operating system looks for files on the F: drive, they will actually be there, although in this case in the RAMdisk rather than on the Hard Disk partition where they were installed.

Step 250 Create a directory on the C: drive called Win98. Create a batch file called boot95.bat which copies all the files, including system files, hidden files and read only files, from the root directory of the C: drive to the Win98 directory using XCOPY/H/K, and then erases all files from the root directory of the C: drive, using:

Attrib -s -h -r C:\*.*
Del C:\*.*

Then again using XCOPY/H/K (DOS 7x version), copy the files back from the Win95 directory to the root directory of the C: drive.

Step 252 Edit the batch file boot98.bat to further copy all the files in c:\win98 to the root directory of the c: drive.

Step 254 When you install programs on the Hyperdrive that need to restart the computer during the installation, be sure to leave the restart option window and run the batch file to Mirror the Hyperdrive to the Hard Disk before you restart the computer, otherwise you will lose the current installation since the Hyperdrive is a volatile drive.

Now, when you are running Windows 95™ on the Hyperdrive, you just need to run the batch file boot98.bat and reboot to start running Windows 98™ on the Hyperdrive. And then if whilst running Windows 98™ on the Hyperdrive you run the batch file boot95.bat and reboot, you will be back running Windows 95™.

This process can obviously be extended to cover three or four installation of all sort of operating systems which can run on top of DOS.

It is actually possible to run both Windows 95™ and Windows 98™ from the same system files in the Root directory of the C: drive, we have done this, but this is not a preferred embodiment.

The following is a description of a preferred and simplified way of running Windows ™ 95 or 98 on both the hard disk and the RAMdisk with capability of swapping from hard disk to RAMdisk and back without rebooting.

We assume that the C: drive is the boot drive. For other boot drive letters please substitute the appropriate drive letter(s).

In the preferred embodiment, running Microsoft Windows™ 95 or 98, we used 750 MB of RAM with 600 configured as a RAMdisk by xmsdsk.exe version 1.9. We used a partition of 500 MB with drive letter D: as the anchor partition and a 2 GB FAT16 partition with drive letter E: as the Hard Disk Mirror. The installation works as follows, with reference to FIG. 5a:

At step 310, install Microsoft Windows™ 95/98 on the D: drive in the directory d:windows. Once it has been installed, at step 312 replace the config.sys file that Windows™ has created with the following file:

Config.sys
Device=c:\sys\himem.sys
Device=c:\sys\ifshlp.sys
Device=c:\sys\dblbuff.sys
Device=c:\sys\setver.exe

At step 314 make sure that the 4 files: Himem.sys, Ifshlp.sys, dblbuff.sys and setver.exe are in the c:\sys directory of your hard drive. Whilst you are at it male sure that subst.exe is aslo there. And make sure that xmsdsk.exe and hdcp.exe are in the c:\hyper directory. Install any missing files as necessary (step 316).

At step 318, boot the machine and run Windows™ 95 from this hard disk partition to make sure that it has been properly installed (you can check the installation with a program such as Norton Utilities if you desire—although in our experience it doesn't help at all).

At step 320, copy the D: partition to the E: partition.

At step 322, make two autoexec.bat files called autoexec.har and autoexec.hyp.

Autoexec.har includes the line:

c:\sys\subst d: e:
Autoexec.hyp includes the lines:
c:\hyper\xmsdsk 600000 r: /c1 /t/y
c:\hyper\hdcp /i-/t-/y e: r:
c:\sys\subst d: r:\

So the autoexec.har merely substitutes the D: drive to be the E: drive. Whereas autoexec.hyp creates a 600 MB RAMdisk at drive letter R:, then copies the E: drive to the R: drive, then substitutes the D: drive to be the R: drive.

At step 324, make two batch files called E.bat and RE.bat. E.bat includes the lines:

c:|sys\subst d: /d
c:\sys\subst d: e:\
exit

This removes any previous substitutions of the D: drive and then substitutes it with the E: drive. RE.bat includes the lines:

c:\hyper\hdcp /i-/t-/y e: r:
c:\sys\subst d: /d
c:\sys\subst d: r:\
exit

This copies the E: drive to the R: drive, then removes any previous substitutions of the D: drive and then substitutes it with the R: drive.

Referring to FIG. 5b, to run the operating system, proceed as follows:

At step 330, if you wish to restart the machine with Windows™ running on the hard disk E:, proceed to step 332, simply copy autoexec.har to autoexec.bat and at step 334 reboot. Continue running the system as normal (step 336).

At step 338, if you wish to swap to RAMdisk operation proceed to step 340, drop to native DOS and, at step 342 run RE.bat. This will restart Windows™ on the RAMdisk without rebooting the PC. Continue running the system (step 344).

If, at step 330, you do not wish to restart the machine with Windows™ running on the hard disk, then proceed to step 348. If you wish to restart the machine with Windows™ running on the RAMdisk Rt:, proceed to step 350, simply copy autoexec.hyp to autoexec.bat and, at step 352 reboot. Continue with your session (step 344).

If, at step 354 you wish to swap back to the Hard disk, proceed to step 356, drop to native DOS and, at step 358 run E.bat. This will restart Windows™ on the Hard Drive without rebooting the machine and you can then continue your session as at step 336.

To swap to the Hard disk one drops to native DOS and runs E.bat (steps 356 and 358). This will restart Windows™ on the Hard Drive without rebooting the machine. To swap back to RAMdisk operation one drops to native DOS and runs RE.bat (steps 340 and 342). This will restart Windows™ on the Hyperdrive without rebooting the PC.

It is important to leave a copy of either Windows™ 95 or Windows™ 98 in the D: drive, which we call the anchor drive. This is because at boot up, before the autoexec.bat is run, which susbstitutes the D: drive with either the R: drive or the E: drive, the system is expecting to find a version of the Windows™ Registry and a copy of System.ini etc at D:\windows. We have called this partition the anchor partition.

1. A method of configuring a computer to run an operating system from RAM, the method comprising:
[1] creating a copy of the operating system on a hard disk at a first address, the operating system being configured to run from a second address;
[2] creating a RAMdisk having a RAMdisk address;
[3] copying the operating system copy from the hard disk to the RAMdisk; and
[4] reconfiguring the computer so that the second address, from which the operating system copy is configured to run is the RAMdisk address or is treated by the computer as being the RAMdisk address, so that said operating system copy can be run on the RAMdisk.

2. The method of claim 1 wherein step [1] comprises creating a partition of a hard disk, said partition having the first address, and creating the copy of the operating system in said partition.

3. The method of claim 1 or claim 2 wherein the first address is a first local address.

4. The method of claim 3 wherein the second address, from which the operating system is configured to run, is the first local address.

5. The method of any preceding claim wherein the RAMdisk address is the second address.

6. The method of any preceding claim wherein step [4] comprises reconfiguring the hardware or software of the computer so that the second address is treated as, or actually becomes, or was at installation of the operating system, the address of the RAMdisk.

7. The method according to any preceding claim including the step of configuring the computer's start up sequence to implement creation of the RAMdisk and copying of the operating system from the hard disk to the RAMdisk.

8. The method of claim 7 wherein creation of the RAMdisk is performed either by running a program operating in DOS or by configuring the BIOS of the computer to create the RAMdisk before the computer starts any operating system.

9. The method of claim 4 wherein step [4] is achieved through either hiding or deleting or removing the drive or partition at the first local address, or by hiding or deleting or removing a partition or a drive with an address different from the first local address, which has the effect of changing the first local address, and the RAMdisk is given the second address, the RAMdisk then having the correct address to run the operating system copy.

10. The method of claim 4 wherein the step of creating the copy of the operating system at the first local address comprises installing the operating system on the hard disk and running a drive letter remapping program to create a copy of the operating system to be used on the Ramdisk, which copy is configured to be run from the second address.

11. The method of claim 10 wherein the drive letter remapping program converts the drive codes (letters) of the instructions within the operating system files to the drive code (letter) to be assigned to the RAMdisk.

12. The method of claim 1 wherein step [4] comprises using an address changing means to substitute the second address with the RAMdisk address.

13. The method of claim 12 wherein the address changing means is used before the operating system is installed at a first local address, so that the computer has already relabelled the second address to be the first local address, and the address substitution is removed after the installation.

14. The method of claim 12 or claim 13 wherein the address substitution means includes use of the DOS SUBST command.

15. The method of any preceding claim further including a step of providing means for copying back whereby changes made within the operating system during running thereof from the RAMdisk are copied back to the hard disk in order to preserve them for subsequent re-booting of the computer.

16. The method of claim 15 wherein the means for copying back to the hard disk is automated as part of the shutting down procedure.

17. The method of any preceding claim further including a step of providing swapping means operable for allowing a user to swap backwards and forwards between running the operating system on the RAMdisk and running the operating system on the hard disk.

18. The method of claim 17 wherein the step of providing swapping means comprises the sub-steps of copying the operating system to a second hard disk or a hard disk partition and providing an address changing means.

19. The method of claim 18 wherein the address changing means comprises means for instructing the computer to change the address of the RAMdisk and the hard disk, which address changing means does not require rebooting of the computer.

20. The method of any preceding claim wherein the operating system is any version of any operating system capable of running Microsoft Word 2000, Access 2000, Excel 2000, and Frontpage 2000.

21. The method of any preceding claim wherein the operating system is any version of Windows 95 or any version of Windows 98.

22. A software carrier medium carrying computer readable code for controlling a processor/computer to carry out the method of any one of claims 1 to 21.

23. A software carrier medium carrying computer readable code executable by a computer for enabling the method of any one of claims 1 to 21 to be implemented by a user of said computer.

24. A computer comprising a hard disk, a CPU and RAM, characterised in that the computer further comprises:
a copy of an operating system installed on a hard disk at a first address, the operating system being configured to run from a second address;
means for creating at a second address a RAMdisk in said RAM;
means for copying the operating system copy from the hard disk to the RAMdisk; and
means for configuring the computer so that the second address, from which the operating system copy is configured to run is the RAMdisk address or is treated by the computer as being the RAMdisk address, so that the operating system copy can be run from the RAMdisk.

25. The computer of claim 24 further including means for copying back the operating system to the hard disk so that changes made during running of the operating system from the RAMdisk are preserved for subsequent re-booting of the computer.

26. The computer of claim 25 wherein the means for copying back is operative for copying back to the hard disk as part of a shutting down procedure.

27. The computer of any one of claims 24 to 26 including a program for configuring the computer's start up sequence to implement said creating and said copying means.

28. The computer of any one of claims 24 to 27 including a program for configuring a swapping means in the computer, the swapping means being operable for allowing a user to swap backwards and forwards between running the operating system on the RAMdisk and running the operating system on the hard disk.
